(19) United States
(12) Patent Application Publication
(10) Pub. No.: US 2015/0363182 A1
(43) Pub. Date: Dec. 17, 2015

(54) SMART DEVICE, WEARABLE DEVICE AND METHOD FOR PUSHING &RECEIVING INSTALLATION PACKAGE

(71) Applicant: MediaTek Singapore Pte. Ltd., Singapore (SG)

(72) Inventor: Yiquan HE, Chengdu (CN)

(21) Appl. No.: 14/736,746

(22) Filed: Jun. 11, 2015

(30) Foreign Application Priority Data
Jun. 11, 2014 (CN) 201410258393.6
Jun. 8, 2015 (CN) 201510309671.0

(51) Int. Cl. G06F 9/445; H04L 29/08

(52) U.S. Cl. CPC G06F 8/61; H04L 67/26; H04L 67/10

(57) ABSTRACT

A method for pushing an installation package from a wearable device to a smart device is provided. The method includes the steps of: pre-storing an installation package required by a smart device into a wearable device; pairing with a smart device via a transmission link; and automatically pushing the installation package to the smart device via the transmission link to install the installation package on the smart device when the wearable device and the smart device are paired with each other for the first time.

### CROSS REFERENCE TO RELATED APPLICATIONS

This application claims priority of China Patent Application No. 201410258393.6, filed on Jun. 11, 2014 and China Patent Application No. 201510309671.0, filed on Jun. 8, 2015, the entirety of which are incorporated by reference herein.

### BACKGROUND OF THE INVENTION

1. Field of the Invention

The disclosure relates generally to mobile communications and, more particularly, to a smart device, a wearable device and method for communication between the wearable device and the smart device.

2. Description of the Related Art

With the development of mobile communication technology, applications of wearable devices (e.g., glasses, watches, etc.) have become more and more popular. To achieve communication between a wearable device and a smart device (such as a smartphone), after these two devices are paired to each other, the smart device may need to acquire installation packages of the smart device's related applications (hereinafter referred to as the installation package) and install it locally, so as to send related operational instructions to the wearable device to obtain data collected by the wearable device and to receive related operational instructions and requests for the wearable device.

Typically, smart devices require connection to the wearable device manufacturer's website through a network to download the installation packages of applications related to the smart device from the website. However, in such cases, users may need to be able to access the website, and the user operation is more complicated. In addition, in an area in which the network is not open, or when the user cannot access the website through a smart device (for example: when there is no phone signal), the installation packages may not be obtained, resulting in a inconvenience for the user.

Therefore, there is a need for a method capable of simply achieving a goal for communication between the wearable device and the smart device.

### BRIEF SUMMARY OF THE INVENTION

A wearable device, a smart device, a method for pushing an installation package from a wearable device to a smart device, and a method for receiving an installation package pushed by a wearable device in a smart device thereof are provided.

In an embodiment, a method for pushing an installation package from a wearable device to a smart device is provided. The method includes the steps of: pre-storing an installation package required by a smart device into a wearable device; pairing with a smart device via a transmission link; and automatically pushing the installation package to the smart device via the transmission link to install the installation package on the smart device when the wearable device and the smart device are paired with each other for the first time.

In another embodiment, a method for receiving an installation package pushed by a wearable device in a smart device is provided. The method includes the steps of: searching neighboring wearable devices and sending a pairing request to each of the searched wearable devices by the smart device; connecting to the wearable device when receiving a reply corresponding to the pairing request from the wearable device by the smart device; receiving the installation package that is automatically pushed by the wearable device via a transmission link; and installing the installation package on the smart device.

Another embodiment of a wearable device includes a storage module, a communication module and a processing module. The communication module is arranged for pairing with a smart device via a transmission link. The processing module is arranged for pre-storing an installation package required by the smart device into the storage module, pairing with the smart device via the transmission link and automatically pushing the installation package to the smart device from the wearable device via the transmission link to install the installation package on the smart device when the wearable device and the smart device are paired with each other for the first time.

Another embodiment of a smart device includes a storage module, a communication module and a processing module. The communication module is arranged for pairing with a wearable device via a transmission link and receiving an installation package pushed by the wearable device via the transmission link. The processing module is arranged for searching neighboring wearable devices and sending a pairing request to each of the searched wearable devices, connecting to the wearable device when receiving a reply corresponding to the pairing request from the wearable device, and installing the installation package on the smart device after receiving the installation package.

Other aspects and features of the present invention will become apparent to those with ordinary skill in the art upon review of the following descriptions of specific embodiments of the wearable devices for carrying out the method for pushing an installation package from a wearable device to a smart device.

### BRIEF DESCRIPTION OF THE DRAWINGS

The invention will become more fully understood by referring to the following detailed description with reference to the accompanying drawings, wherein:

FIG. 1 is a schematic diagram illustrating an architecture including a wearable device and a smart device according to an embodiment of the invention;

FIG. 2 is a schematic diagram illustrating a brief structure of pushing an installation package from the wearable device to the smart device according to an embodiment of the invention;

FIG. 3 is a timing diagram illustrating pushing an installation package from the wearable device to the smart device according to an embodiment of the invention;

FIG. 4 is a flowchart of a method for pushing an installation package from the wearable device to the smart device according to an embodiment of the invention; and

FIG. 5 is a flowchart of installation package reception of the smart device according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

It should be understood that the following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numbers and/or letters in the various examples. This repetition is for the purpose of simplicity and clarity and does not in itself dictate a relationship between the various embodiments and/or configurations discussed. Furthermore, the formation of a first feature over or on a second feature in the description that follows may include embodiments in which the first and second features are formed in direct contact, and may also include embodiments in which additional features may be formed between the first and second features, such that the first and second features may not be in direct contact.

Embodiments of the present invention provide a simple method for communication between a smart device and a wearable device, through pre-storing installation packages of the smart device related applications (such as an Android™ package, or APK) into the wearable device, after the wearable device is successfully paired with the smart device for the first time, the installation package can be quickly and automatically pushed to the smart device through a common wired or wireless communication protocol between the smart device and the wearable device, such as universal serial bus (USB), near-field communications (NFC), Bluetooth (BT) and other transmission protocol technology and can then be installed on the smart device by the user, so as to send related operational instructions to the wearable device to obtain the data collected by the wearable device as well as to receive operational instructions and requests for the wearable device through the installation package that was installed, thus enabling communication between the wearable device and the smart device.

The invention can be more fully understood by reading the subsequent detailed description and examples with reference to the accompanying drawings.

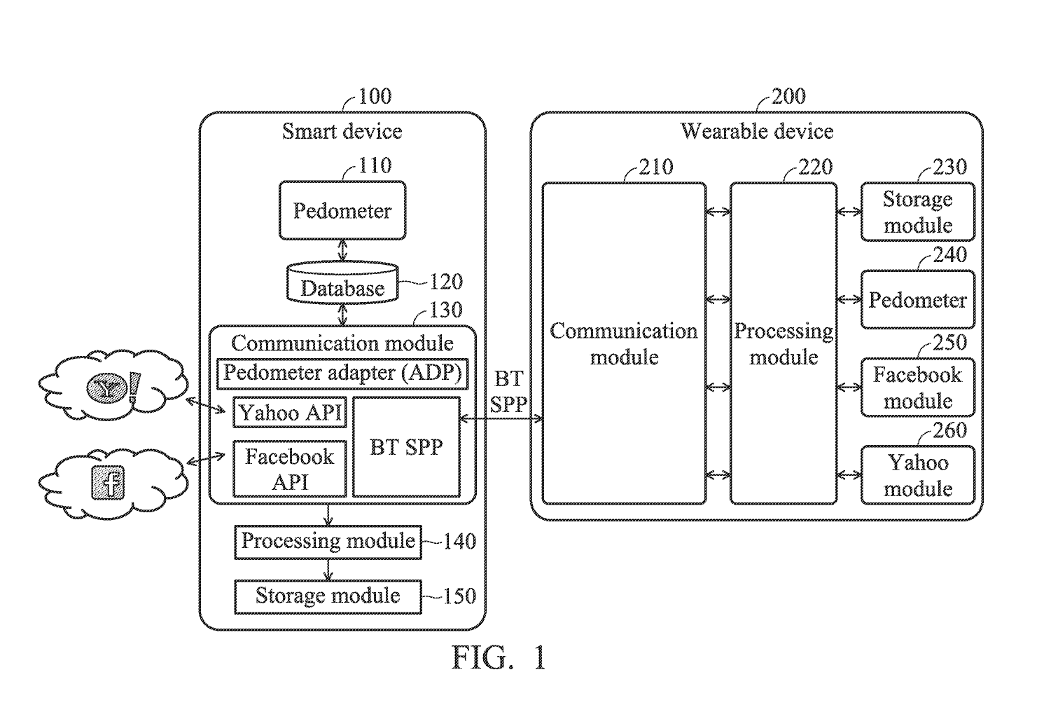

FIG. 1 is a schematic diagram illustrating an architecture including a wearable device and a smart device according to an embodiment of the invention. It should be noted that the smart device and the wearable device may include, for example, an Android client for illustrative purposes, and the invention is not limited thereto. The smart device 100 may be a mobile phone, a smartphone, a tablet PC, a portable media player (PMP), a handheld gaming console and so on. As shown in FIG. 1, the smart device 100 may comprise a pedometer 110, a database 120, a communication module 130, a processing module 140 and a storage module 150. The communication device 130 further comprises a pedometer adapter (ADP) connected to the database 120, a variety of wired and wireless connection modules such as a BT connection module, and optionally contains applications provided by third parties, such as the Facebook API, MSN, QQ, Wechat, Weibo for instant messaging and so on, as well as other applications with real-time notifications or other features, such as Yahoo API and so on. Taking the Yahoo API and Facebook API as an example, the Yahoo API and Facebook API may be coupled to a server of a third-party application provider through a wireless or wired connection to separately implement corresponding operations. Correspondingly, the wearable device 200 may also comprise a communication module 210 coupled to the communication module 130, a processing module 220, a storage module 230, a pedometer 240, a Facebook module 250, a Yahoo module 260, and the like. It should be understood that persons skilled in the art will understand that the above-described modules or APIs can be implemented by hardware or software modules, and the invention is not limited thereto.

The communication module 210 may include a variety of wired and wireless connection modules such as a USB connection module, a NFC connection module, or a BT connection module, which may be connected to the communication module 130 of the smart device 100 to pair to the smart device 100 through a wireless transmission using a responsive wired or wireless transmission method, such as a USB transmission protocol technology or a NFC, BT, IEEE802.11, HomeRF technology, IrDA, ZigBee, WiFi or another communication protocol, so as to communicate with the smart device 100.

The processing module 220 may include a processor and a signal processing circuit. The processor may be a Central Processing Unit (CPU), Micro-Control Unit (MCU), Digital Signal Processor (DSP), or the like, which provides the function of data processing and computing. More particularly, the processing module 220 may load and execute a series of instructions and/or program codes from the storage module 230 to control the operation of the communication module 210, the storage module 230, the pedometer 240, the Facebook module 250, and the Yahoo module 260, for performing the method for pushing an installation package from a wearable device to a smart device of the invention. The method includes the steps of pre-storing an installation package required by the smart device 100 into storage module 230 of the wearable device 200, pairing with the smart device 100 via a transmission link through the communication module 210 and automatically pushing the installation package pre-stored in the storage module 230 to the smart device 100 via the transmission link to install the installation package at the smart device 100 side when the wearable device 200 and the smart device 100 are paired with each other for the first time.

In this embodiment, the storage module 230 of the wearable device 200 may be a non-volatile storage media (e.g., Read-Only Memory (ROM), Flash memory, magnetic tape, hard disk, or optical disc), or a volatile storage media (e.g., Random Access Memory (RAM)), or any combination thereof for storing data, such as instructions, program codes, input data from users, installation packages and so on. The storage module 230 may further include a file system (e.g., a File Allocation Table (FAT)), and the installation package is being pre-stored in the file system of the storage module 230 for subsequent use.

According to one embodiment of the present invention, during the communication process of the smart device 100 and the wearable device 200, the installation package of related applications of the smart device 100 is stored in the wearable device 200 in advance, in which the installation package may be utilized to send related operational instructions to the wearable device 200 and obtain the data collected by the wearable device 200 as well as to receive operational instructions and requests for the wearable device 200. Then, after the wearable device 200 and the smart devices 100 are connected to each other using their communication modules 210 and 130, respectively, via a wired or wireless transmission, such as a Universal Serial Bus (USB) technology or Near Field Communication (NFC), Bluetooth (BT), IEEE802.11, HomeRF technology, IrDA, ZigBee, Wifi or other wireless transmission and they are successfully paired at the first time, the installation package is automatically pushed to the smart device 100 via the aforementioned wired or wireless transmission, such as the Bluetooth or another short-range communication transmission. Thereafter, upon receipt of the installation package by the smart device 100, the smart device 100 may prompt the user of the smart device 100 to indicate that an installation package has received so that the user can install the installation package on the smart device 100. The smart device 100 may then return the pushing and installation result back to the wearable device 200 so the wearable device 200 can know whether the pushing of the installation package was successful, so as to determine whether the auto pushing of the installation package to a paired smart device 100 is required again in a subsequent process. In addition, if, after the pairing, the pushing of the installation package was not successful for some reason, the installation package will be automatically pushed to the smart device 100 again the next time there is a connection, until the installation package has successfully been pushed to the smart device 100.

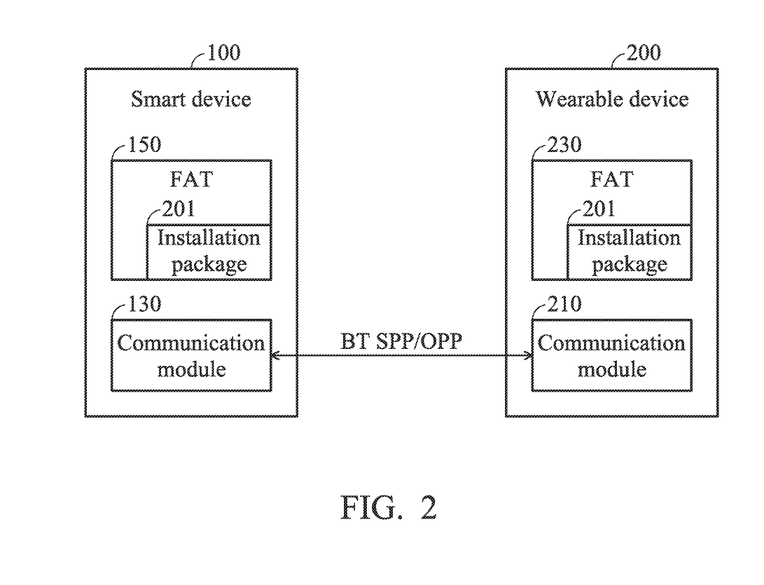

FIG. 2 is a schematic diagram illustrating a brief structure of pushing an installation package from the wearable device to the smart device according to an embodiment of the invention. As shown in FIG. 2, first, an installation package 201 required by the smart device 100 is pre-stored in the dedicated memory space of the wearable device 200 such as the file system (e.g., the FAT) of the storage module 230. When the communication module 130 (e.g., a BT connection module) of the smart device 100 sends a request for connecting to the wearable device 200 and the connection therebetween is successful, the wearable device 200 checks whether the installation package has been pushed to the smart device 100. The wearable device 200 may further determine whether the installation package has been pushed to the smart device 100 based on a pushing result for the installation package recorded. If it is determined that the installation package has not been pushed to the smart device 100 yet, the communication module 210 (e.g., a BT connection module) of the wearable device 200 will then push the installation package 201 to the smart device 100 through the communication protocol corresponding to the communication module 210 (e.g., BT SPP or OPP). Thus, the smart device 100 will store the installation package 201 in the storage module 150. Then, the user can install the installation package 201 on the smart device 100 and perform communication between the smart device 100 and the wearable device 200 through the installation package that was installed.

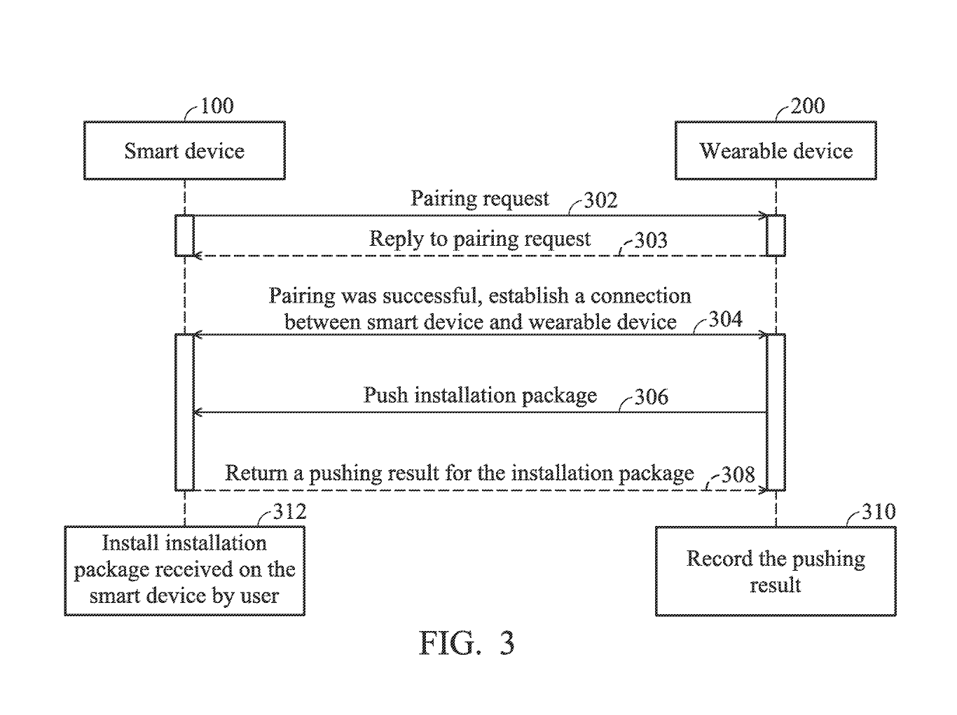

FIG. 3 is a timing diagram illustrating pushing an installation package from the wearable device to the smart device according to an embodiment of the invention. The smart device 100 first has searched neighboring wearable device 200 and sends a pairing request to the searched wearable device 200 via Bluetooth or another short-range communication technology (step 302). After receiving a reply corresponding to the pairing request from the wearable device 200 (step 303), the smart device 100 connects to the wearable device 200 (step 304); then, the wearable device 200 determines whether to push the installation package to the smart device 100 depending on the situation (step 306). After the pushing of the installation package is completed, the paired smart device 100 may return a pushing result to the wearable device 200 (step 308), to inform the wearable device 200 whether it has received a pushed installation package. The wearable device 200 may record the pushing result (step 310), and the user can install the installation package received on the smart device 100 (step 312). In other words, the wearable device 200 may determine whether the installation package has been successfully pushed to the smart device 100 based on the pushing result recorded. In one embodiment, the step of the wearable device 200 determining whether to push the installation package to the smart device 100 depending on the situation may further comprise determining, by the wearable device 200, whether the installation package has been successfully pushed to the smart device according to the pushing result recorded. When it is determined that the installation package has not been pushed to the smart device 100, the wearable device 200 may determine to push the installation package to the smart device 100 via the Bluetooth communication protocol. In another embodiment, the step of the wearable device 200 determining whether to push the installation package to the smart device 100 depending on the situation may further comprise: when it is determined that the installation package has already been pushed to the smart device 100, which means the installation package has already been pushed to the currently paired smart device 100, there is no need to push the installation package any more, and thus the wearable device 200 may determine not to push the installation package to the smart device 100, thereby skipping the process of pushing the installation package.

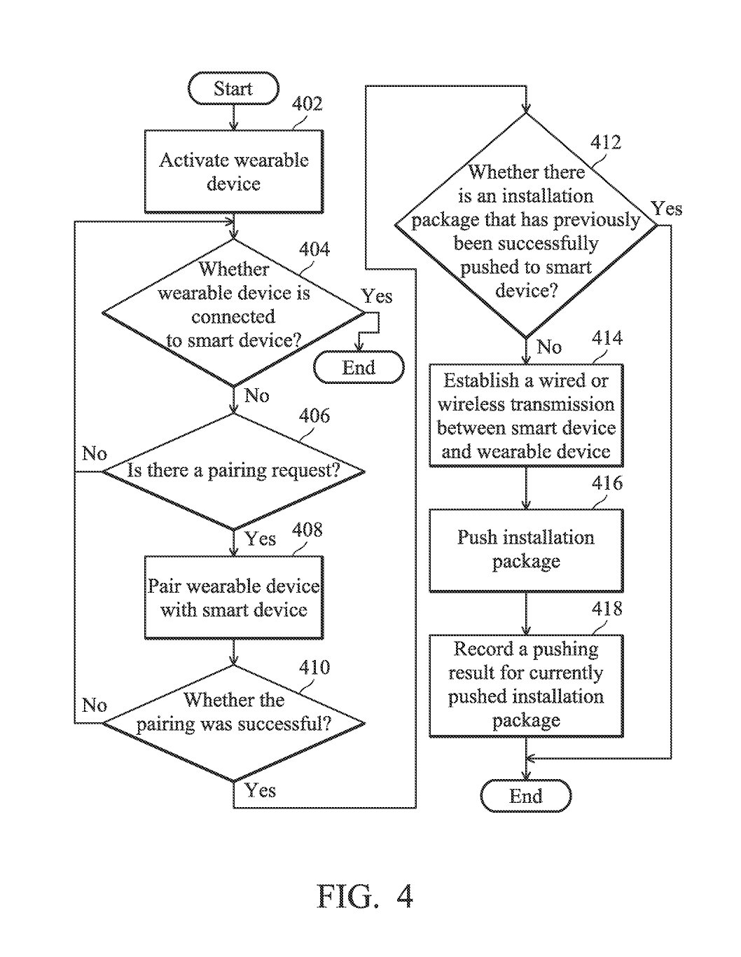

FIG. 4 is a flowchart of a method for pushing an installation package from the wearable device to the smart device according to an embodiment of the invention. The flowchart of the method for pushing the installation package from the wearable device to the smart device can be applied to a wearable device, such as the wearable device 200 as shown in FIG. 1 and can be performed by the processing module 220 that loads and executes a series of instructions and/or program codes from the storage module 230 to control the operation of the communication module 210, the storage module 230, the pedometer 240, the Facebook module 250, and the Yahoo module 260, for performing the method for pushing the installation package from the wearable device to the smart device of the invention. The method includes the following steps. First, in step 402, the wearable device is activated and then in step 404, it is determined whether the wearable device is connected to the smart device. If the wearable device has connected to the smart device (Yes in step 404), it means that the wearable device should previously have been successfully paired with the smart device, and thus the pushing process of the installation package can be skipped. If the wearable device has not connected to the smart device yet (No in step 404), in step 406, it is further determined whether there is a pairing request from the smart device. If it is determined that there is a pairing request from the smart device, in step 408, the wearable device is being paired with the smart device. Then, in step 410, it is further determined whether the pairing was successful. If it is determined that the pairing was not successful, or if there is no pairing request from the smart device in step 406, the method returns to step 404 until there is a new connection to the smart device or a new pairing request from the smart device. If it is determined that the pairing was successful in step 410, it is then determined in step 412 whether there is an installation package that has previously been successfully pushed to the smart device according to the pushing result recorded in the storage module. If the answer is positive, it means that the pushing of the installation package to the currently paired smart device has previously been completed successfully, and thus the subsequent pushing process can be skipped. If the answer is negative, which means that the installation package has not previously pushed to the currently paired smart device, or that the pushing of the installation package has failed, in step 414, a wired or wireless transmission (e.g., BT SPP or OPP connection) between the smart device and the wearable device is established, and then in step 416, the installation package is pushed to the smart device through the aforementioned wired or wireless transmission (e.g., the BT SPP or OPP connection). After the pushing of the installation package is completed or aborted, step 418 is performed to enable the wearable device to record a receiving result for currently pushed installation package for use in a subsequent query.

Note that the step of establishing the wired or wireless transmission (e.g., BT SPP or OPP connection) between the smart device and the wearable devices in step 414 and the step of pushing the installation package from the wearable device to the smart device via the above-mentioned wired or wireless transmission (e.g., BT SPP or OPP connection) in step 416 can have a variety of implementations. In one embodiment, the pushing of the installation package can be performed using a BT connection such as SPP and OPP. SPP is a Bluetooth serial port protocol, wherein when the smart device and the wearable device are connected through SPP, they can send data to or receive data from each other. SPP can support the continuous transmission of large amounts of data, for example, for transferring files. OPP is another Bluetooth protocol, which is mainly used for file transfer. In another embodiment, the pushing of the installation package can be performed using an NFC connection. Specifically, the smart device 100 may search the neighboring/surrounding wearable device 200, and send a pairing request through the NFC. After the pairing is successful, the smart device 100 may request to connect to the wearable device 200 via the near field communication and the wearable device 200 may then determine whether to push the installation package to the smart device 100 through the near field communication depending on the situation. In some embodiments, the pushing of the installation package can be performed using a wired connection, such as a USB connection. Specifically, the smart device 100 may send a pairing request for connecting to the wearable device 200 through the USB connection. After the pairing is successful, the smart device 100 may connect to the wearable device 200 via the USB connection and the wearable device 200 may then determine whether to push the installation package to the smart device 100 through the USB connection therebetween, depending on the situation.

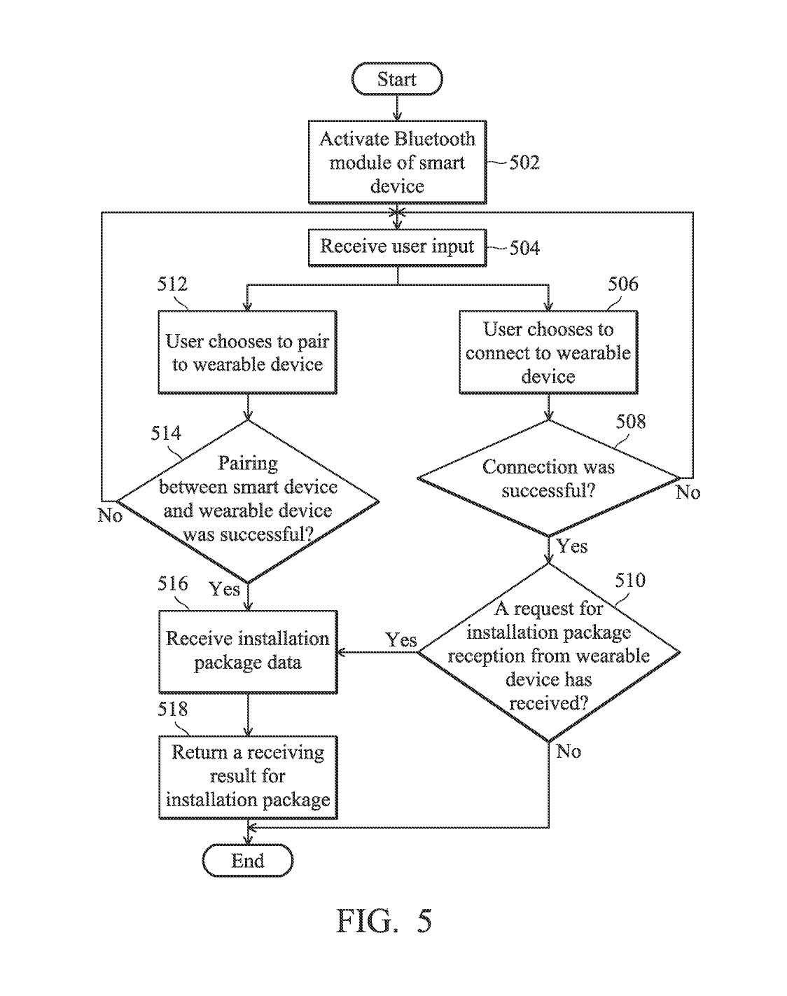

FIG. 5 is a flowchart of installation package reception of the smart device according to an embodiment of the invention.

In this embodiment, a BT connection such as SPP and OPP connection is used as an example of the pushing of the installation package. It should be understood that persons skilled in the art will understand that the above-described pushing of the installation package can be implemented by other wired or wireless connections, and the invention is not limited thereto. As shown in FIG. 5, first, in step 502, the Bluetooth module of the smart device is activated, then in step 504, the smart device receives user input, wherein it can be determined whether the user selects to connect to the wearable device or pair to the wearable device through user input. If the user chooses to connect to the wearable device (step 506), then it is determined whether the connection was successful in step 508. If it is determined as the connection has failed (No in step 508), then the method returns to step 504 to wait for subsequent user input. If it is determined as the connection was successful in step 508, then in step 510, the smart device determines whether it has received a request for installation package reception from the wearable device. If the request was not received (No in step 510), the method ends. If the request was received (Yes in step 510), step 516 is proceeded. If the user chooses to pair to the wearable device in step 504 (step 512), it is then determined in step 514 whether the pairing between the smart device and the wearable device was successful. If it is determined that the pairing was a failure (No in step 514), then the method returns to step 504 to wait for subsequent user input. If it is determined as the pairing was successful in step 514, step 516 is performed to receive the installation package data from the wearable device. When receipt of the installation package is completed or aborted, then in step 518, the smart device returns a receiving result for the installation package to the smart device.

Therefore, according to the embodiments of the invention, the smart device, such as an Android terminal, can install the installation package pushed by the wearable device the first time it is paired with the wearable device, so as to establish communication between the smart device and the wearable device through the installation package that was installed. One of the beneficial effects is that there is no limitations on the ability to access the website through this technology, so that user operation is relatively simple and it is also applicable even in an area where the network is not open. The automatic pushing and installation of installation packages can be achieved without requiring networking, thereby increasing convenience of use. On the other hand, the downloading of installation packages in the embodiments of the invention can be done automatically, thus facilitating the promotion on the use of wearable device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for pushing an installation package from a wearable device to a smart device, comprising:
pre-storing the installation package required by the smart device into the wearable device; and
pairing with the smart device via a transmission link and automatically pushing the installation package to the smart device from the wearable device via the transmission link to install the installation package on the smart device when the wearable device and the smart device are paired with each other for the first time.

2. The method of claim 1, wherein the installation package is automatically pushed to the smart device via a Bluetooth protocol, a near field communication (NFC) protocol or a universal serial bus (USB) transmission protocol.

3. The method of claim 1, further comprising:
recording a pushing result by the wearable device after the installation package is automatically pushed to the smart device.

4. The method of claim 3, wherein the step of automatically pushing the installation package to the smart device from the wearable device further comprises:
determining whether the installation package has been successfully pushed to the smart device according to the pushing result recorded by the wearable device; and
determining to push the installation package to the smart device when the wearable device determines that the installation package has not been pushed to the smart device.

5. The method of claim 4, wherein the step of automatically pushing the installation package to the smart device from the wearable device further comprises:
determining not to push the installation package to the smart device when the wearable device determines that the installation package has already been pushed to the smart device.

6. The method of claim 1, wherein the installation package is pre-stored in a file system of the wearable device.

7. A method for receiving an installation package pushed by a wearable device in a smart device, comprising:
searching neighboring wearable devices and sending a pairing request to each of the searched wearable devices by the smart device;
connecting to the wearable device when receiving a reply corresponding to the pairing request from the wearable device by the smart device;
receiving the installation package that is automatically pushed by the wearable device via a transmission link; and
installing the installation package on the smart device.

8. The method of claim 7, further comprising returning a receiving result for the installation package to the wearable device after receiving the installation package.

9. The method of claim 7, wherein the transmission link further comprises a Bluetooth, a near field communication (NFC) or a universal serial bus (USB) transmission link.

10. The method of claim 7, wherein the installation package received is stored in a file system of the smart device.

11. A wearable device, comprising:
a storage module;
a communication module for pairing with a smart device via a transmission link; and
a processing module for pre-storing an installation package required by the smart device into the storage module, pairing with the smart device via the transmission link and automatically pushing the installation package to the smart device from the wearable device via the transmission link to install the installation package on the smart device when the wearable device and the smart device are paired with each other for the first time.

12. The wearable device of claim 11, wherein the communication module further automatically pushes the installation package to the smart device via a Bluetooth protocol, a near field communication (NFC) protocol or a universal serial bus (USB) transmission protocol.

13. The wearable device of claim 11, wherein the processing module further automatically pushes the installation package to the smart device upon connecting to the smart device and records a pushing result after the pushing of the installation package to the smart device is completed.

14. The wearable device of claim 13, wherein the processing module further determines whether the installation package has been successfully pushed to the smart device according to the pushing result recorded and determines to push the installation package to the smart device when determining that the installation package has not been pushed to the smart device.

15. The wearable device of claim 14, wherein the processing module further determines not to push the installation package to the smart device when determining that the installation package has already been pushed to the smart device.

16. The wearable device of claim 11, wherein the installation package is pre-stored in a file system of the storage module.

17. A smart device, comprising:
a storage module;
a communication module for pairing with a wearable device via a transmission link and receiving an installation package pushed by the wearable device via the transmission link; and
a processing module for searching neighboring wearable devices and sending a pairing request to each of the searched wearable devices, connecting to the wearable device when receiving a reply corresponding to the pairing request from the wearable device, and installing the installation package on the smart device after receiving the installation package.

18. The smart device of claim 17, wherein the processing module further returns a receiving result for the installation package to the wearable device via the communication module after receiving the installation package.

19. The smart device of claim 17, wherein the transmission link further comprises a Bluetooth, a near field communication (NFC) or a universal serial bus (USB) transmission link.

20. The smart device of claim 17, wherein the installation package received is stored in a file system of the smart device.
